(19) United States
(12) Patent Application Publication
(10) Pub. No.: US 2026/0045754 A1
(43) Pub. Date: Feb. 12, 2026

(54) OPTICAL FIBER FOR AMPLIFICATION AND CLADDING-PUMPED OPTICAL FIBER AMPLIFIER

(71) Applicant: NTT, Inc., Tokyo (JP)

(72) Inventors: Taiji SAKAMOTO, Musashino-shi, Tokyo (JP); Ryota IMADA, Musashino-shi, Tokyo (JP); Kazuhide NAKAJIMA, Musashino-shi, Tokyo (JP)

(73) Assignee: NTT, Inc., Tokyo (JP)

(21) Appl. No.: 18/998,236

(22) PCT Filed: Aug. 15, 2022
(86) PCT No.: PCT/JP2022/030893

§ 371 Date: Jan. 24, 2025

(51) Int. Cl. H01S 3/067; H01S 3/094

(52) U.S. Cl. CPC H01S 3/06733; H01S 3/06737; H01S 3/094007

(57) ABSTRACT

An object of the present invention is to improve efficiency of an amplifying L band signal.

The present disclosure is an optical fiber doped with a rare earth element for amplification, in which the optical fiber for amplification includes two or more cores in a cross section of a cladding, a core density C obtained by dividing number of cores by a cladding area is 0.0008 μm² or more, and a core radius a is 1 μm or more and 3.5 μm or less.

### TECHNICAL FIELD

The present invention relates to an optical fiber amplifier.

### BACKGROUND ART

In an optical fiber communication system, light being propagated through an optical fiber and suffering optical loss is amplified and relayed by an optical amplifier at every fixed distance, and thereby a long-distance transmission is performed. In the amplification in the optical amplifier, signal light and pump light (mainly light with 980 nm or 1480 nm as the condition of erbium-doped optical fiber (EDF) using erbium) for exciting a rare earth element are injected into an optical fiber for amplification (mainly EDF) in which the rare earth element is a dopant in a core region, and the light is amplified without converting it into electricity.

In the present communication using a single mode optical fiber (SMF), a core pumping type optical amplifier is used for amplifying signal light propagated through the core by guiding a pump light to the core in the same manner. On the other hand, in recent years, an optical fiber for space division multiplexing (SDM), using a multi-core fiber having a plurality of cores in a cross section of an optical fiber or a few-mode fiber having or more modes of propagation in the core studied for increasing the transmission capacity of the optical fiber, has been studied, and an amplifier, for an optical fiber, in which a plurality of spatial modes are propagated through one optical fiber thereof has been studied (for example, NPL 1).

With respect to these SDM optical fibers, an optical fiber amplifier for SDM for simultaneously amplifying a plurality of spatial modes has been studied (for example, NPL 2). In NPL 2, unlike the core pumping method, a cladding pumping type optical fiber amplifier for guiding the pump light to a cladding region of an optical fiber and collectively amplifying a plurality of cores or a plurality of modes has been studied. The cladding pumping type optical fiber amplifier can use a multi-mode light source as the pump light, which exhibits power efficiency superior to that of a single mode light source generally used in the core pumping type and does not always require temperature control by a Peltier element necessary for the single mode light source, and the cladding pumping type optical fiber amplifier is expected to exhibit excellent amplification efficiency.

The cladding pumping type optical fiber amplifier has a low overlap between a region through which the pump light is propagated and a core region which is doped with rare earth elements, and a small pump light quantity absorbed in an optical fiber for amplification as compared with the core pumping system, which are problems. However, a study has been proceeded in respect of increasing the pump light quantity absorbed in the optical fiber by increasing a core-to-cladding ratio Rcc, which is a ratio between a total area of the core in the optical fiber and a cladding area involving the core area, and has demonstrated a high amplification efficiency (for example, NPL 3).

### CITATION LIST

### Non Patent Literature

[NPL 1] Y. Tsuchida et al., “Amplification characteristics of a multi-core erbium-doped fiber amplifier,” in Proc. of OFC2012, paper OM3C. 3 (2012)
[NPL 2] K.S.Abedin et al., “Cladding-pumped erbium-doped multicore fiber amplifier,” Opt. Express, vol. 20, No. 18, pp. 20191-20200 (2012)
[NPL 3] T. Sakamoto et al., “Characteristics of Randomly Coupled 12-core Erbium-Doped Fiber Amplifier,” J. of Lightw. Technol. vol. 39, No. 4, pp. 1186-1193 (2021)
[NPL 4] S. Takasaka et al., “EDF length dependence of amplification characteristics of cladding pumped 19-core EDFA,” in Proc. of OFC2018, paper Th1K.2 (2018)

### SUMMARY OF INVENTION

### Technical Problem

However, in respect of increasing the amplification efficiency by increasing the Rcc, efforts have been aimed only at a study by using an optical fiber amplifier for amplifying a C band ranging from 1530 to 1565 nm, so that a structural condition of the optical fiber, for amplification, for realizing the high efficiency amplification is not clear in an optical fiber amplifier for amplifying an L band ranging from 1565 to 1610 nm which is one of the low loss communication wavelength bands of the optical fiber.

In general, an EDF length for amplifying the L band is longer than an EDF length of the C band amplifier, and the study, centering around the non-coupled multicore fiber, has reported that the pump light quantity absorbed in the full EDF length is more than that of the C band, which is caused by the longer EDF length and improves amplification efficiency (e.g., NPL 4).

However, as described in NPL 3, experimental results in which the amplification efficiency is reduced in an L band amplifier having a long EDF even with the same optical fiber structure have been reported, and the structural conditions of the optical fiber, for amplification, for realizing a high-efficiency L band optical amplifier have been unknown.

An object of the present invention is to improve efficiency of an amplifying L band signal.

### Solution to Problem

The present disclosure solves the above problem, and provides an optical fiber amplifier that amplifies a signal in an L band with high efficiency.

An optical fiber for amplification according to the present disclosure is
an optical fiber doped with a rare earth element for amplification,
in which the optical fiber for amplification includes two or more cores in a cross section of a cladding,
a core density C obtained by dividing number of cores by a cladding area is 0.0008 μm² or more, and
a core radius a is 1 μm or more and 3.5 μm or less.

A cladding pumping type optical fiber amplifier of the present disclosure includes:
the optical fiber for amplification of the present disclosure; a pump light combiner for injecting a pump light into a cladding region of the optical fiber for amplification; and
a pump light source for supplying a multi-mode pump light to the pump light combiner.

The cladding may include
a first cladding positioned around the core, and
a second cladding positioned around the first cladding, the cladding area may be determined by using an area of the first cladding.

A length of the optical fiber for amplification is adjusted to amplify an L band denoting 1565 nm or more and 1610 nm or less.

The above disclosures can be combined as far as possible.

### Advantageous Effects of Invention

The amplification efficiency of the L band signal can be improved by the optical fiber for amplification of the present invention.

### BRIEF DESCRIPTION OF DRAWINGS

FIG. 1A illustrates a forward pumping type configuration example of a cladding pumping type optical fiber amplifier according to the present disclosure.

FIG. 1B illustrates a backward pumping type configuration example of a cladding pumping type optical fiber amplifier according to the present disclosure.

FIG. 2 illustrates an example of a cross-sectional structure of an optical fiber for amplification according to the present disclosure.

FIG. 3 illustrates an example of amplification characteristics calculated in accordance with a model of a multi-core fiber amplifier.

FIG. 4 illustrates an example of amplification characteristics where a cladding diameter is set to a value selected from 80, 100, and 125 μm.

FIG. 5 illustrates an example of calculation results of PCE contour lines coordinating a core density and a core radius a.

FIG. 6 illustrates the calculation results of PCE with various erbium doping concentrations.

FIG. 7 is a calculation result of contour lines of core density coordinating the number of cores and cladding diameter.

### DESCRIPTION OF EMBODIMENTS

Hereinafter, embodiments of the present disclosure will be described in detail with reference to the drawings. The present disclosure is not limited to the embodiments described below. The embodiments are merely examples, and the present disclosure can be implemented in various modified and improved modes based on knowledge of those skilled in the art. Constituent elements with the same reference numerals and signs in the present specification and the drawings are the same constituent elements.

Embodiments of the present disclosure will be described below with reference to the drawings.

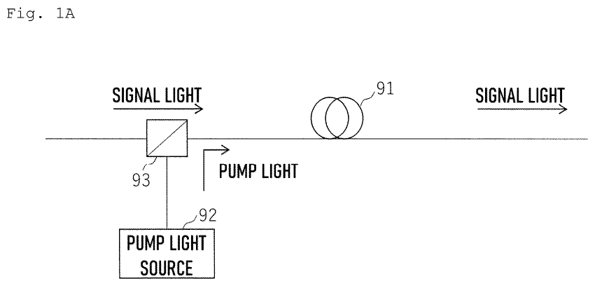

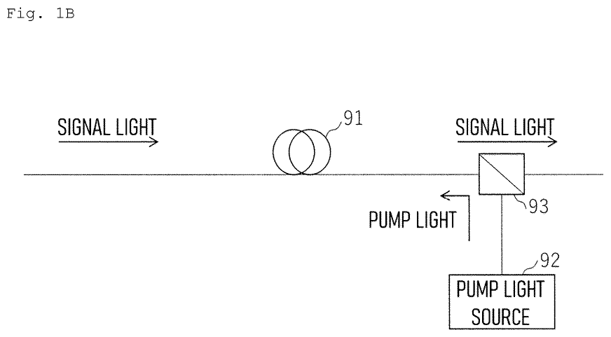

FIGS. 1A and 1B illustrate the configuration of a cladding pumping type optical fiber amplifier according to the present disclosure. A pump light combiner 93, for multiplexing a pump light from a pump light source 92 for supplying the pump light, is capable of being connected to any one of input/output terminals of an optical fiber 91 doped with the rare earth element for amplification, and signal light guided through a core of the optical fiber 91 for amplification is amplified.

Although it is typical that an isolator is connected to the input/output terminal in accordance with a propagation direction of the signal light, the isolator is omitted in this drawing. Further, a residual pump light remover may be provided for emitting the pump light, which is not absorbed into the optical fiber 91 for amplification, out of the optical fiber. FIGS. 1A and 1B illustrate a forward pumping type in which the pump light is injected into a side of signal light injection, and a backward pumping type in which the pump light is injected into an emitting side, respectively. In general, the multi-mode pump light emitted from the pump light source 92 is coupled to an optical fiber having a core diameter set to 105 μm.

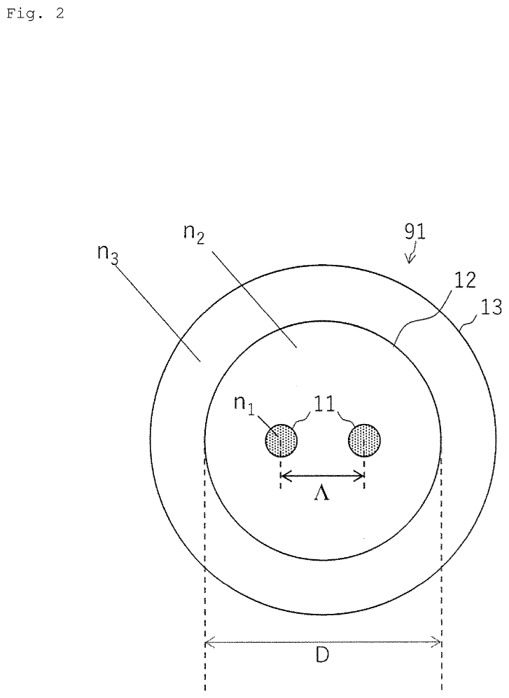

FIG. 2 illustrates an example of a cross-sectional configuration of the optical fiber 91 for amplification according to the present disclosure. Although the drawing is a cross-sectional view of a multi-core optical fiber in which cores 11 are two cores, the multi-core optical fiber in use can be an optical fiber having three or more cores in a square lattice shape, a hexagonal close-packed structure, or an annular core arrangement. There is a region of the core 11 with a refractive index n₁ and a region of the cladding 12 with a refractive index n₂, and there is a magnitude relation expressed by n₁>n₂. In the structure of the drawing, the condition represented by n₁>n₂ can be realized by using, as the material of each region, pure quartz glass, or quartz glass doped with impurities for increasing the refractive index such as germanium (Ge), aluminum (Al), or phosphorus (P), or impurities for reducing the refractive index such as fluorine (F) or boron (B). Also, an inter-core distance is expressed by Λ.

The optical fiber 91 for amplification according to the present disclosure includes a second cladding 13 having a refractive index lower than that of the cladding 12. Hereinafter, the cladding 12 surrounding the core 11 may be referred to as a first cladding, and the cladding 13 surrounding the first cladding may be referred to as a second cladding.

In general, the second cladding 13 may be a glass cladding having a refractive index lower than that of the first cladding 12, which is brought about by dopant such as fluorine or the like, in addition to a resin having a refractive index lower than that of the first cladding 12. In the optical fiber 91 for amplification, a part or the whole region of the core 11 or a region, covering the peripheral claddings 12 and 13, around the core is doped with a rare earth element.

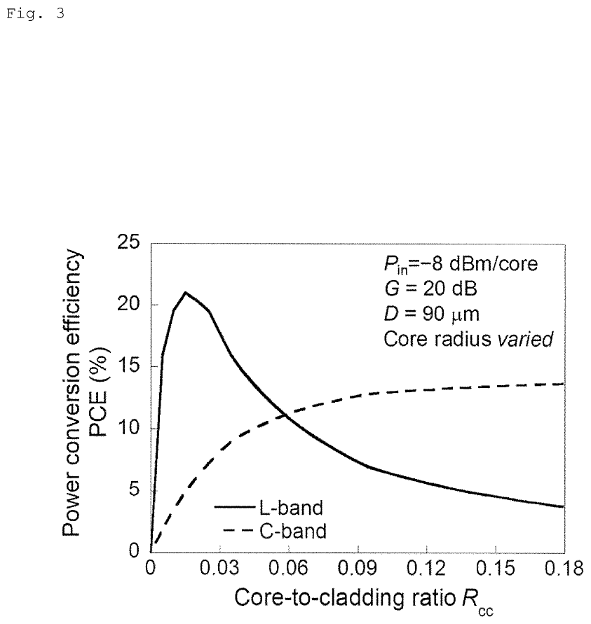

FIG. 3 illustrates the amplification characteristics calculated in accordance with the model of the multi-core fiber amplifier described in NPL 2. A vertical axis denotes a power conversion efficiency (PCE), which is defined as PCE=(Pₛ₁−Pₛ₀)/Pₚ: the pump light intensity is Pₚ, the input signal light intensity is Pₛ₀, and the output signal light intensity is Pₛ₁.

In the drawing, the above expression is converted into a percentage obtained by centuplication. A horizontal axis denotes a core-to-cladding ratio Rcc.

A cladding area, then, denotes an area of the cladding through which the pump light is guided, and is defined as the area of the first cladding 12, and the core area of a multi-core fiber including two or more cores 11 is defined as the sum of the areas of the individual cores 11.

In this calculation, the injection power per core 11 is set to −8 dBm, the diameter of the cladding 12 is fixed to 90 μm, and the core radius a of each core 11 is changed to change Rcc. In the drawing, a broken line is the calculation result where the C band signal is amplified, and a solid line is the calculation result where the L band signal is amplified. The C band is a 4-wave WDM signal having signal light wavelengths 1530, 1540, 1550, and 1565 nm, and the L band is a 4-wave WDM signal having signal wavelengths 1570, 1580, 1590, and 1600 nm. In each instance, the gain is set to 20 dB, and the EDF length and the pump light intensity are adjusted so that the gains of the signals of the shortest wave wavelength and the longest wave wavelength of the WDM signal become the same. The number of cores is 12, the wavelength of pump light is 980 nm, and the erbium doping concentration to the core is 6×10²⁴ ions/m³.

The figure shows that the cladding pumping type L band optical fiber amplifier requires a ration Rcc within a specific range to obtain a high PCE, and that the optical fiber amplifier is not capable of providing high-efficiency amplification by simply increasing Rcc unlike the C band optical fiber amplifier.

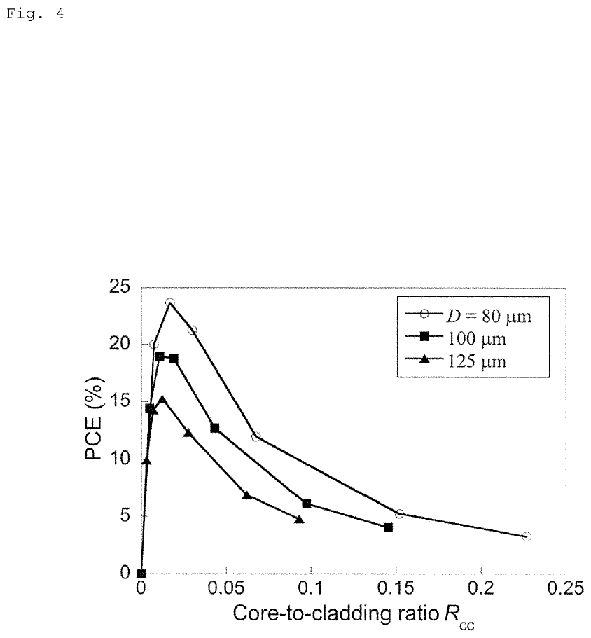

FIG. 4 illustrates the results of calculation where the cladding diameter D are set to 80, 100, and 125 μm, though each of them is similar to that of FIG. 3. The value of Rcc, at which the PCE becomes maximum, is shown to be independent of the cladding diameter D and hardly change. On the other hand, the change in the cladding diameter D and the fixation of Rcc show that PCE becomes higher by setting the cladding diameter D on the small side.

Calculation confirms that the Rcc is constant and the PCE characteristics are the same, with the same core density (the number of cores/the cladding area) kept, under the condition of a constant core diameter. For example, when a condition where the number of cores is 12 and the cladding diameter D is 100 μm, and a condition where the number of cores is 3, signifying one-fourth of the above, the cladding diameter D is 50 μm, signifying one-half of the above, that is, the cladding diameter D sets the cladding area one-fourth of that of the above condition and the core diameter is the same as that of the above condition, the Rcc vs. PCE characteristic curves are exactly the same. That is, FIG. 4 is not limited to the embodiment where the number of cores is 12; the drawing can be regarded as a generalized comparison of characteristics between three core densities.

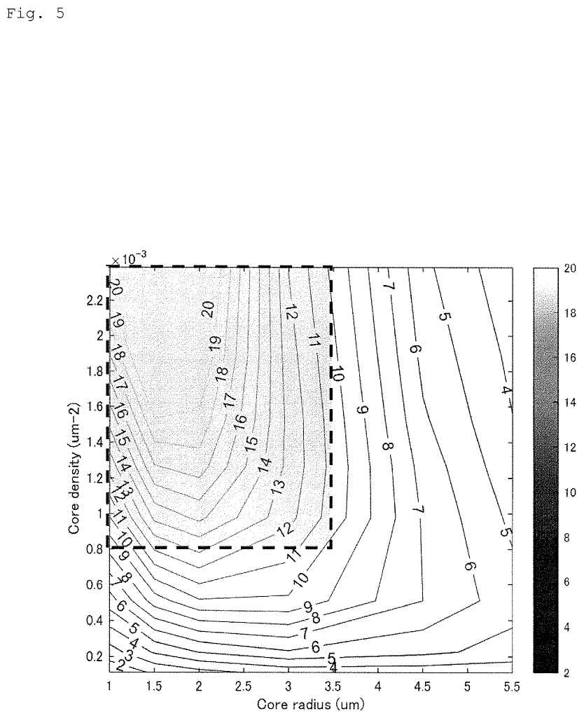

FIG. 5 illustrates the calculation results of the contour lines of PCE coordinating core density and core radius calculated under the same conditions and procedures as those of the calculations in FIGS. 3 to 4. According to NPL 3, among the C band amplifiers reported so far, the highest PCE is shown to be 10%, and the requirements for obtaining characteristics equivalent to this are shown to be the followings.
(i) core density C>0.0008 μm²
(ii) 1 μm<core radius a<3.5 μm

Thus, the optical fiber for amplification of the present disclosure can improve the amplification efficiency of an L band signal denoting 1565 nm or more and 1610 nm or less.

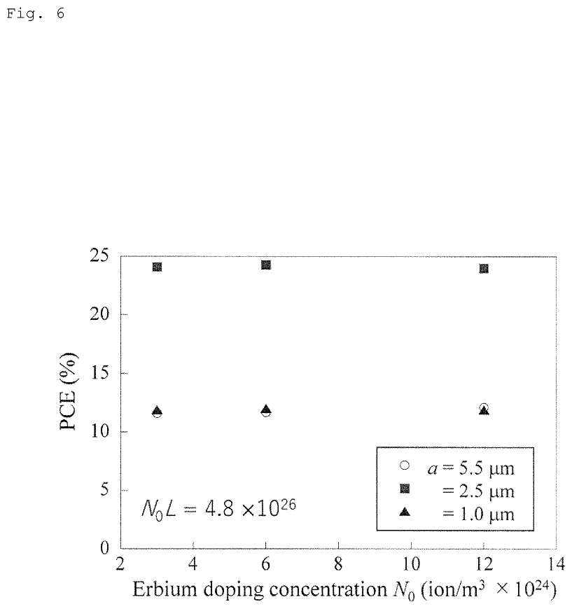

In this calculation, the erbium doping concentration N₀ is fixed to 6×10²⁴ ions/m³, but the Rcc range is not changed even by a doping concentration fixed to another. FIG. 6 illustrates the calculation result of the PCE with the various erbium doping concentrations. The number of cores is 12, and the core radius a is set to a variable value selected from 1.0, 2.5, and 5.5 μm. When the erbium addition amount increases or decreases, it is necessary to change the EDF length to obtain the same amplification characteristics, and in this calculation result, the product of the erbium doping concentration No and the EDF length L is constant at 4.8×10²⁶ (ions/m²). The drawing shows that the characteristics of the PCE are unchanged by adjusting the EDF length, to obtain the same amplification characteristics, even with any erbium doping concentration. That is, the condition for obtaining a high PCE in the L band optical fiber amplifier does not depend on the erbium doping concentration.

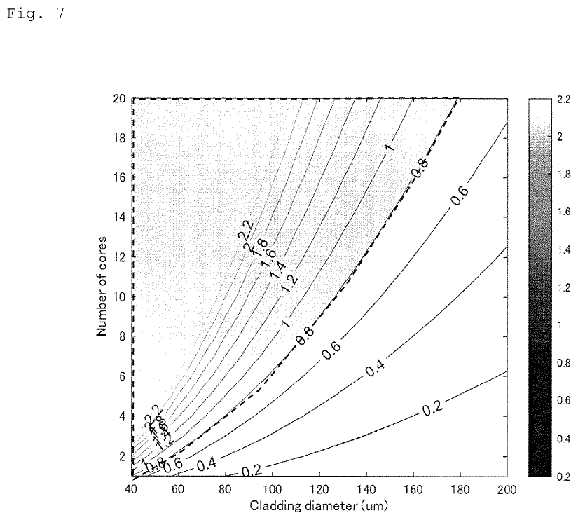

FIG. 7 illustrates the calculation result of contour lines of core density coordinating the number of cores and the cladding diameter D. A region surrounded by the broken line is a region that represents the core density C>0.0008 μm² mentioned earlier. Since the conventional MCF structures described in NPLs 1 and 4 are designed on the basis of the non-coupled multi-core structure, the inter-core distance is 30 μm or more, and accordingly, the cladding diameter D tends to be large and the core density tends to be small. Therefore, such a designed region is considered to have provided a core density lower than the core density targeted by the present disclosure. Therefore, the past examination results mean that the present disclosure cannot be easily inferred therefrom.

For example, in the optical fiber described in NPL 4, the number of cores is 19 and the cladding diameter D is 200 μm, and according to FIG. 7, the core density is deemed to be 0.0008 μm² or less. In addition, in regard to NPL 3, although the core density is 0.0008 μm² or more, the core radius, which is 5.5 μm, is not in line with the requirements of the present disclosure.

In regard to the adjustment of the amplification band of the optical fiber amplifier, for example, when an erbium-doped optical fiber, as described in NPL 4, is adopted, 10 m or so brings about a characteristic of amplifying the C band, the severalfold (for example, 60 to 100 m) shifts the amplification band to an L band denoting 1565 nm or more and 1610 nm or less, and an L band amplifier can be realized. As a specific procedure, an L band amplifier can be realized by the procedure followed in order of increasing the length of the optical fiber 91 for amplification under inspection of the amplification band, or shortening the fiber length of an excessively long optical fiber for amplification under inspection of the amplification band, and tuning the fiber length to an optimal fiber length bringing about the desired amplification in the L band wavelength band.

### REFERENCE SIGNS LIST

11 Core
12 First cladding
13 Second cladding
91 Fiber for amplification
92 Pump light source
93 Pump light combiner

1. An optical fiber doped with a rare earth element for amplification,
wherein the optical fiber for amplification comprises two or more cores in a cross section of a cladding,
a core density C obtained by dividing number of cores by a cladding area is 0.0008 μm² or more, and
a core radius a is 1 μm or more and 3.5 μm or less.

2. The optical fiber for amplification according to claim 1,
wherein the cladding comprises
a first cladding positioned around the core, and
a second cladding positioned around the first cladding,
wherein the cladding area is determined by using an area of the first cladding.

3. A cladding pumping type optical fiber amplifier comprising:
the optical fiber for amplification according to claim 1;
a pump light combiner for injecting a pump light into a cladding of the optical fiber for amplification; and
a pump light source for supplying a multi-mode pump light to the pump light combiner.

4. The cladding pumping type optical fiber amplifier according to claim 3,
wherein a length of the optical fiber for amplification is adjusted to amplify a band denoting 1565 nm or more and 1610 nm or less.
